(19) United States
(12) Patent Application Publication
(10) Pub. No.: US 2024/0165515 A1
(43) Pub. Date: May 23, 2024

(54) GAME INTERACTION METHOD AND APPARATUS, ELECTRONIC DEVICE, AND STORAGE MEDIUM

(71) Applicant: NETEASE (HANGZHOU) NETWORK CO., LTD., Hangzhou, Zhejiang (CN)

(72) Inventor: Yichen HAN, Hangzhou, Zhejiang (CN)

(21) Appl. No.: 18/282,912

(22) PCT Filed: Apr. 21, 2022
(86) PCT No.: PCT/CN2022/088264

§ 371 Date: Sep. 19, 2023

(30) Foreign Application Priority Data
Jan. 7, 2022 (CN) 202210015982.6

(51) Int. Cl. A63F 13/56; A63F 13/533

(52) U.S. Cl. CPC A63F 13/56; A63F 13/533

(57) ABSTRACT

An in-game interaction method and apparatus, an electronic device and a storage medium are provided. The method includes: in response to a control instruction by a first user with respect to a first virtual skill of a first controlled virtual object, obtaining position coordinates of the first controlled virtual object in a virtual scene; obtaining a second controlled virtual object within a preset range with the position coordinates as a reference, the second controlled virtual object being controlled by a second user; determining whether the initial outline information of the second controlled virtual object is consistent with current outline information; and displaying, in the graphical user interface of the first user, prompt information that the second controlled virtual object is a camouflaged object, if it is determined that the initial outline information is inconsistent with the current outline information.

### CROSS-REFERENCE TO RELATED APPLICATIONS

The present disclosure is the U.S. National Stage Application of PCT International Application No. PCT/CN2022/088264, filed on Apr. 21, 2022, which is based on and claims the priority to the Chinese patent application with the filing No. 202210015982.6 filed on Jan. 7, 2022, entitled “In-game Interaction Method and Apparatus, Electronic Device, and Storage Medium”, the entire contents of both of which are incorporated by reference herein for all purposes.

### TECHNICAL FIELD

The present disclosure relates to the technical field of human-computer interaction, in particular to an in-game interaction method and apparatus, an electronic device, and a storage medium.

### BACKGROUND

With the development of computer technologies and Internet technologies, there are more and more types of games. Asymmetric stealth games are one of the important types of games. In stealth games, a plurality of players in the same match are divided into two camps, namely, a sneaking party and a chasing party. The sneaking party sneaks into a designated place to execute a task, and may need to camouflage and obtain relevant task information during the task execution. The chasing party needs to identify, pursue, and capture the sneaking party from the crowd to prevent the sneaking party from completing the task.

However, in the stealth games, the sneaking party can be camouflaged as an NPC (non-player character), which makes it difficult for the camouflaged sneaking party to confront the chasing party, resulting in long match time and low interaction efficiency between users.

### SUMMARY

A first aspect of the present disclosure provides an in-game interaction method, which includes: obtaining, by a terminal, position coordinates of a first controlled virtual object in a virtual scene, in response to a control instruction of a first user for a first virtual skill of the first controlled virtual object; obtaining, by the terminal, a second controlled virtual object within a preset range in accordance with the position coordinates used as reference, where the second controlled virtual object is controlled by a second user; determining, by the terminal, whether initial appearance information of the second controlled virtual object is consistent with current appearance information; and displaying prompt information that the second controlled virtual object is a camouflaged object, in a graphical user interface of the first user, in response to determining that the initial appearance information is inconsistent with the current appearance information.

A second aspect of the present disclosure further provides an electronic device, which includes a processor, a memory and a bus, where the memory stores machine-readable instructions executable by the processor, the processor communicates with the memory through the bus when the electronic device runs, and the processor is configured for executing the machine-readable instructions to perform steps of an in-game interaction method, where the in-game interaction method comprises: obtaining position coordinates of a first controlled virtual object in a virtual scene, in response to a control instruction of a first user for a first virtual skill of the first controlled virtual object; obtaining a second controlled virtual object within a preset range in accordance with the position coordinates as reference, where the second controlled virtual object is controlled by a second user; determining whether initial appearance information of the second controlled virtual object is consistent with current appearance information; and displaying prompt information that the second controlled virtual object is a camouflaged object, in a graphical user interface of the first user, in response to determining that the initial appearance information is inconsistent with the current appearance information.

A third aspect of the present disclosure further provides a non-transitory computer-readable storage medium, computer programs are stored on the computer-readable storage medium, and the computer programs, when run by a processor, perform the steps of an in-game interaction method, where the in-game interaction method comprises: obtaining position coordinates of a first controlled virtual object in a virtual scene, in response to a control instruction of a first user for a first virtual skill of the first controlled virtual object; obtaining a second controlled virtual object within a preset range in accordance with the position coordinates as reference, where the second controlled virtual object is controlled by a second user; determining whether initial appearance information of the second controlled virtual object is consistent with current appearance information; and displaying prompt information that the second controlled virtual object is a camouflaged object, in a graphical user interface of the first user, in response to determining that the initial appearance information is inconsistent with the current appearance information.

### BRIEF DESCRIPTION OF DRAWINGS

In order to illustrate the embodiments of the present disclosure more clearly, the drawing which needs to be used in the description of the embodiments will be briefly introduced below. It should be understood that the drawings only show some embodiments of the present disclosure, so they shall not be regarded as limiting the scope. For those ordinarily skilled in the art, other relevant drawings may be obtained in light of the drawings without paying creative efforts.

FIG. 1 shows a flowchart of an in-game interaction method provided by one or more embodiments of the present disclosure;

FIG. 2 shows a schematic view of an interface for selecting a target uncontrolled virtual object provided by one or more embodiments of the present disclosure;

FIG. 3 shows a structural schematic view of an in-game interaction apparatus provided by one or more embodiments of the present disclosure; and

FIG. 4 shows a structural schematic view of an electronic device provided by one or more embodiments of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are only some rather than all of the embodiments of the present disclosure. Generally, the components of the embodiments of the present disclosure described and illustrated in the drawings herein may be arranged and designed in various different configurations. Therefore, the following detailed description of the embodiments of the present disclosure provided in the drawings is not intended to limit the claimed scope of protection of the present disclosure, but only represents selected embodiments of the present disclosure. Based on the embodiments of the present disclosure, every other embodiment obtained by those skilled in the art without paying creative efforts shall fall within the scope of protection of the present disclosure.

The terms “a”, “an”, “the” and “said” used in this specification are intended to indicate the existence of one or more elements or components, etc. The terms “including/comprising” and “having” are intended to indicate an open-ended inclusion and mean that other elements or components, etc. may exist in addition to the listed elements or components, etc. The terms “first” and “second”, etc. are only used as marks, and are not intended to limit the number of objects.

It should be understood that in the embodiments of the present disclosure, “at least one” indicates one or more, and “a plurality of” indicates two or more. The term “and/or” only indicates an association relationship describing the related objects, which indicates that there may be three kinds of relationships. For example, “A and/or B” may indicate that A exists alone, A and B exist at the same time, or B exists alone. In addition, the character “/” in the present disclosure generally indicates that the contextual objects have an “or” relationship. The term “including A, B and/or C” indicates including any one or any two or three of A, B and C.

It should be understood that in the embodiments of the present disclosure, “B corresponding to A”, “A corresponds to B” or “B corresponds to A” indicates that B is associated with A, and B may be determined according to A. Determining B according to A does not mean determining B only according to A, but B may also be determined according to A and/or other information.

First, the applicable application scenarios of the present disclosure are introduced as follows. The present disclosure may be applied to game scenes, and the embodiments of the present disclosure does not limit the specific application scenes, and any solution using the interaction method and apparatus, the electronic device and the storage medium provided by the embodiments of the present disclosure shall fall within the scope of protection of the present disclosure.

It is worth noting that before the present disclosure is proposed, with the development of computer technologies and Internet technologies, there are more and more types of games. Asymmetric stealth games are one of the important types of games. In stealth games, a plurality of players in the same match are divided into two camps, namely, a sneaking party and a chasing party. The sneaking party sneaks into a designated place to execute a task, and may need to camouflage and obtain relevant task information during the task execution. The chasing party needs to identify, pursue and capture the sneaking party from the crowd to prevent the sneaking party from completing the task. However, in stealth games, the sneaking party can be camouflaged as an NPC (non-player character), which makes it difficult for the camouflaged sneaking party to confront the chasing party, resulting in the problems of long match time and low interaction efficiency between users.

Based on this, embodiments of the present disclosure provide an in-game interaction method and apparatus, an electronic device, and a storage medium, which may improve the interaction efficiency between users and shorten the match time, and may solve the problems of long match time and low interaction efficiency between users in stealth games.

In order to facilitate those skilled in the art to better understand the present disclosure, the in-game interaction method and apparatus, the electronic device and the storage medium provided by embodiments of the present disclosure will be introduced in detail below.

Referring to FIG. 1, which is a flowchart of an in-game interaction method provided by embodiments of the present disclosure. As shown in FIG. 1, the in-game interaction method provided by the embodiments of the present disclosure includes:

Step S101: obtaining position coordinates of a first controlled virtual object in a virtual scene, in response to a control instruction of a first user for a first virtual skill of the first controlled virtual object;

Step S102: obtaining a second controlled virtual object within a preset range with the position coordinates as reference, where the second controlled virtual object is controlled by a second user;

Step S103: determining whether initial appearance information of the second controlled virtual object is consistent with current appearance information; and

Step S104: displaying prompt information that the second controlled virtual object is a camouflaged object, in a graphical user interface of the first user, if it is determined that the initial appearance information is inconsistent with the current appearance information.

First, the terms involved in the embodiments of the present disclosure are briefly introduced below.

Terminal

The terminal involved in the embodiments of the present disclosure mainly refers to an intelligent device for providing the virtual scene of the current virtual battle and controlling the controlled virtual object. The terminal may include, but is not limited to, any one of the following devices: a smart phone, a tablet computer, a portable computer, a desktop computer, a game console, a personal digital assistant (PDA), an e-book reader and an MP4 (Moving Picture Experts Group Audio Layer IV) player. An application program that supports virtual scenes of games, such as an application program that supports three-dimensional game scenes, is installed and run in the terminal. The application program may include, but is not limited to, any one of the following: a virtual reality application program, a three-dimensional map program, a military simulation program, a MOBA game, a multiplayer shootout survival game, and a third-personal shooting game (TPS).

Graphical User Interface:

The graphical user interface is an interface display format for communication between a person and a computer, and allows the user to manipulate icons, identifiers or menu options in the screen by using an input device such as a mouse or a keyboard, and also allows the user to manipulate icons or menu options in the screen by performing touch operations on the touch screen of a touch terminal, to select command(s), start program(s) or execute other task(s).

Virtual Scene:

The virtual scene is a virtual scene that is displayed (or provided) when an application program is run on a terminal or a server, that is, a scene used during normal playing of a game. In other words, the virtual scene refers to a virtual game control that carries a virtual object during playing of the game, and the virtual object may move, release skills and perform other actions in the virtual scene under the operating instructions issued by the user (that is, the player) to the terminal. In some examples, the virtual scene may be a simulation environment for the real world, a semi-simulation and semi-fictional virtual environment, or a purely fictional virtual environment. The virtual scene may be any one of a two-dimensional virtual scene, a 2.5-dimensional virtual scene and a three-dimensional virtual scene, and the virtual environment may be a sky, a land, an ocean, etc., where the land includes environmental elements such as a desert and a city, etc. In the above, the virtual scene is the scene where the user controls the whole game logic of the virtual object. In some examples, the virtual scene may also be used for a virtual environment battle between at least two virtual objects, and in the virtual scene, there are virtual resources available for the at least two virtual objects. Exemplarily, a virtual scene may include any one or more of the following elements: a game background element, a game virtual character element, a game prop element, etc.

Virtual Object:

The virtual objects refer to the controlled virtual object(s) and the uncontrolled virtual object(s) in the virtual environment. The controlled virtual object may be a virtual character controlled by the player, including but not limited to at least one of a virtual person, a virtual animal, and a cartoon person. The uncontrolled virtual object may be a virtual character (NPC) not controlled by the player. The uncontrolled virtual object may also be a virtual item, which refers to a static object in the virtual scene, such as a virtual prop in the virtual scene, a virtual task, and a position, a terrain, a house, a bridge, vegetation in the virtual environment, etc. The static object is often not directly controlled by the player, but may conduct corresponding behaviors in respond to the interaction behavior(s) (such as attacks, demolitions, etc.) of the virtual object in the virtual scene. For example, the virtual object may demolish, pick up, drag, and build buildings, etc. In some examples, the virtual item may fail to respond to the interaction behavior(s) of the virtual object. For example, the virtual item may also be a building, a door, a window, vegetation, etc. in the virtual scene, but the virtual object cannot interact with the virtual item, for example, the virtual object cannot destroy or demolish the window. In some examples, when the virtual scene is a three-dimensional virtual environment, the virtual character may be a three-dimensional virtual model, and each virtual character has its own shape and volume in the three-dimensional virtual environment, occupying a part of space in the three-dimensional virtual environment. In some examples, the virtual character is a three-dimensional character constructed based on the three-dimensional human skeleton technology, and the virtual character achieves different appearances by wearing different skins. In some examples, the virtual character may also be implemented by using a 2.5-dimensional or two-dimensional model, which is not limited by the embodiments of the present disclosure.

There may be a plurality of controlled virtual objects in the virtual scene, which are virtual characters controlled by players (i.e., characters controlled by players through input devices), or Artificial Intelligences (AI) trained for virtual environment battle(s). In some examples, the controlled virtual object is a virtual person competing in the virtual scene. In some examples, the number of the controlled virtual objects in the virtual scene battle is preset or dynamically determined according to the number of terminals participating in the virtual battle, which is not limited by the embodiment of the present disclosure. In one possible example, the user can control the controlled virtual object to move in the virtual scene, for example, control the controlled virtual object to run, jump, crawl, etc., and can control the controlled virtual object to use the skills and virtual props, etc. provided by the application program to fight with other controlled virtual objects.

In some examples according to the present disclosure, the terminal may be a local terminal. Taking the game as an example, the local terminal stores the game program and is configured for presenting the game screens. The local terminal is configured for interacting with the player through the graphical user interface, that is, the game program is conventionally downloaded, installed and run through the electronic device. The local terminal may provide the graphical user interface to the player in various ways, for example, it may be rendered and displayed on the display screen of the terminal, or it may be provided to the player through holographic projection. For example, the local terminal may include a display screen for presenting a graphical user interface which includes a game scene screen, and a processor for running the game, generating the graphical user interface, and controlling the displaying of the graphical user interface on the display screen.

The applicable application scenes of the present disclosure are introduced as follows. The present disclosure can be applied to the technical field of games, where in the game, a plurality of players participating in the game jointly participate in the same virtual battle.

Before entering the current virtual battle, the players may select different character attributes, such as identity attributes, for their own controlled virtual objects in the current virtual battle. By assigning different character attributes to determine different camps, the players can win the game by executing the tasks assigned by the game in different match stages of the current virtual battle. For example, a plurality of controlled virtual objects with the A character attribute can win the game by “eliminating” the controlled virtual objects with the B character attribute in the match stage. Here, it is also possible to randomly assign character attributes to each controlled virtual object participating in the current virtual battle, when entering the current virtual battle.

An implementation environment provided by an embodiment of the present disclosure may include a first terminal, a game server and a second terminal. The first terminal and the second terminal communicate with the game server respectively to implement data communication. In the present embodiment, the first terminal and the second terminal are respectively installed with an application program for performing the in-game interaction method provided by the present disclosure, and the game server is the server side for performing the in-game interaction method provided by the present disclosure. Through the application program, the first terminal and the second terminal can communicate with the game server respectively.

Taking the first terminal as an example, the first terminal establishes communication with the game server by running the application program. In some examples according to the present disclosure, the game server establishes the current virtual battle according to the game request of the application program. In the above, the parameter(s) of the current virtual battle may be determined according to the parameter(s) in the received game request. For example, the parameters of the current virtual battle may include the number of people participating in the virtual battle, the levels of characters participating in the virtual battle, etc. When the first terminal receives the response from the game server, the virtual scene corresponding to the current virtual battle is displayed through the graphical user interface of the first terminal. In some examples according to the present disclosure, the game server determines, for the application program, the current virtual battle from a plurality of established virtual battles according to the game request of the application program, and when the first terminal receives the response from the game server, the virtual scene corresponding to the current virtual battle is displayed through the graphical user interface of the first terminal. The first terminal is a device controlled by a first user, the controlled virtual object displayed in the graphical user interface of the first terminal is a player character controlled by the first user (i.e., the first controlled virtual object), and the first user inputs an operation instruction through the graphical user interface to control the player character to perform corresponding operation in the virtual scene.

Taking the second terminal as an example, the second terminal establishes communication with the game server by running the application program. In some examples according to the present disclosure, the game server establishes the current virtual battle according to the game request of the application program. In the above, the parameter(s) of the current virtual battle may be determined according to the parameter(s) in the received game request. For example, the parameters of the current virtual battle may include the number of people participating in the virtual battle, the levels of characters participating in the virtual battle, etc. When the second terminal receives the response from the game server, the virtual scene corresponding to the current virtual battle is displayed through the graphical user interface of the second terminal. In some examples according to the present disclosure, the game server determines, for the application program, the current virtual battle from a plurality of established virtual battles according to the game request of the application program, and when the second terminal receives the response from the game server, the virtual scene corresponding to the current virtual battle is displayed through the graphical user interface of the second terminal. The second terminal is a device controlled by a second user, the controlled virtual object displayed in the graphical user interface of the second terminal is a player character controlled by the second user (i.e., the second controlled virtual object), and the second user inputs an operation instruction through the graphical user interface to control the player character to perform corresponding operation in the virtual scene.

The game server performs data calculation according to the game data reported by the first terminal and the second terminal, and synchronizes the calculated game data to the first terminal and the second terminal, so that the first terminal and the second terminal control the graphical user interface to render the corresponding virtual scene and/or virtual objects according to the synchronous data sent by the game server.

In this embodiment, the first controlled virtual object controlled by the first terminal and the second controlled virtual object controlled by the second terminal are virtual objects in the same virtual battle. In the above, the first controlled virtual object controlled by the first terminal and the second controlled virtual object controlled by the second terminal may have the same character attributes or different character attributes, and the first controlled virtual object controlled by the first terminal and the second controlled virtual object controlled by the second terminal belong to different camps.

It should be noted that the controlled virtual objects in the current virtual battle may include two or more virtual objects, and different controlled virtual objects may correspond to different terminals, that is, in the current virtual battle, there are more than two terminals to perform sending and synchronizing of game data with the game server respectively.

The in-game interaction method provided by the embodiments of the present disclosure may determine the camouflaged second controlled virtual object within the preset range of the first controlled virtual object, and give a corresponding prompt in the graphical user interface of the first user, solving the problems of long match time and low interaction efficiency between users. Compared with the interaction method in the prior art, the match time is shortened, and the interaction efficiency between users is improved, thus helping to speed up the game progress.

The following takes the above method applied to a terminal as an example for illustration of the above-mentioned exemplary steps provided by the embodiments of the present disclosure.

In step S101, the first user may refer to a user who uses the first terminal, and the first user represents the user who controls the first controlled virtual object.

The control instruction may refer to the instruction issued by the first user through the first terminal, and the control instruction is configured for controlling the controlled virtual object to release virtual skills.

As an example, the control instruction may be an operation instruction received through an external input device (such as a keyboard and/or a mouse) connected to the terminal, or the terminal may be a device with a touch screen, in which case the control instruction may be a touch operation instruction executed on the touch screen.

Exemplarily, the control instruction may include, but is not limited to, at least one of the following: a single-click operation instruction, a double-click operation instruction, a long-press operation instruction, and a voice instruction.

The first controlled virtual object may refer to the specific controlled virtual object of the chasing party controlled by the first user who uses the first terminal, and only the specific controlled virtual object of the chasing party has the first virtual skill, the second virtual skill, the third virtual skill and the fourth virtual skill.

As an example, the first controlled virtual object may be some hero with the above-mentioned virtual skills, but other heroes of the chasing party do not have the above-mentioned virtual skills. The first controlled virtual object may perform a confrontational behavior against the second controlled virtual object in the virtual scene by releasing the virtual skills.

In the embodiment of the present disclosure, after the first user controls the first controlled virtual object to release the first virtual skill, the position coordinates of the first controlled virtual object at the moment when the first virtual skill is released may be determined.

In step S102, the preset range may refer to a set range, and the preset range is configured for determining the second controlled virtual object near the first controlled virtual object.

As an example, the preset range may be a range with a regular shape or a range with an irregular shape.

Exemplarily, the regular shape may be, but is not limited to, any one of the following: circle, rectangle, square, ellipse, semicircle, sector, trapezoid.

The second user may refer to the user who uses the second terminal, and the second user represents the user who controls the second controlled virtual object.

The second controlled virtual object may refer to the controlled virtual object of the sneaking party controlled by the second user. The second controlled virtual object is a virtual object controlled by another player who is in the hostile camp and plays the game together in the current virtual battle. For example, the first controlled virtual object belongs to the chasing party camp, and the second controlled virtual object belongs to the sneaking party camp opposite to the chasing party camp.

The second controlled virtual object may defeat the uncontrolled virtual object by releasing a normal attack skill or other virtual skills. Then, when approaching the defeated uncontrolled virtual object, the second controlled virtual object may obtain the appearance information of the uncontrolled virtual object through the first universal virtual skill, to be camouflaged as the defeated uncontrolled virtual object. At the same time, the second controlled virtual object may also remove camouflage at any time through the second universal virtual skill, to restore its original appearance.

It should be noted that the first universal virtual skill and the second universal virtual skill are universal virtual skills that only the sneaking party has, and the chasing party does not have the above universal virtual skills. It can be understood that the first controlled virtual object belongs to the chasing party, so the first controlled virtual object does not have the first universal virtual skill and the second universal virtual skill.

In the embodiments of the present disclosure, after determining the position coordinates of the first controlled virtual object in the virtual scene, the virtual objects in the virtual scene within a preset range around the first controlled virtual object may be scanned to obtain the second controlled virtual object within the preset range.

In step S103, the appearance information may refer to the model information of the controlled virtual object, and the appearance information is configured for representing the appearance of the controlled virtual object.

Exemplarily, the appearance information includes, but is not limited to, at least one of model information and action information.

The model information includes the skin information corresponding to the model and the skeleton information of the model.

The initial appearance information may refer to the appearance information of the controlled virtual object when just entering the current game. The initial appearance information is configured for determining whether the controlled virtual object is in the initial state, that is, the state before camouflage.

The current appearance information may refer to the appearance information of the controlled virtual object at the current moment, and the current appearance information is configured for determining whether the controlled virtual object is in the camouflaged state.

The initial state is configured for determining whether the controlled virtual object is in the camouflaged state. The initial state is configured for representing the state of the first controlled virtual object using the initial appearance information.

The camouflaged state is configured for distinguishing from the initial state of the controlled virtual object. The camouflaged state is configured for representing the state of the first controlled virtual object using the appearance information of the target uncontrolled virtual object.

It should be noted that the first user may control the first controlled virtual object to select an uncontrolled virtual object, and obtain the appearance information of the selected uncontrolled virtual object, to use the obtained appearance information of the uncontrolled virtual object to change its own initial appearance and implement the camouflage of the first controlled virtual object. In the above, there are a plurality of uncontrolled virtual objects in the virtual scene, which have different types of appearance information. For example, there are 10 uncontrolled virtual objects, in which the appearance information of 2 uncontrolled virtual objects is type A, the appearance information of 3 uncontrolled virtual objects is type B, and the appearance information of 5 uncontrolled virtual objects is type C. When the first user controls the first controlled virtual object to release the second virtual skill, an uncontrolled virtual object of type A may be selected, the appearance information of the selected type A may be obtained, and the first controlled virtual object may be controlled to change from having the initial appearance information to having the appearance information of type A, thus completing the camouflage.

In the embodiments of the present disclosure, after determining the second controlled virtual object within the preset range, it is necessary to judge whether the second controlled virtual object within the preset range is in the camouflaged state, that is, judge whether the initial appearance information of the second controlled virtual object within the preset range is consistent with the current appearance information. If the initial appearance information of the second controlled virtual object is consistent with the current appearance information of the second controlled virtual object, it indicates that the second controlled virtual object is not in the camouflaged state. If the initial appearance information of the second controlled virtual object is inconsistent with the current appearance information of the second controlled virtual object, it indicates that the second controlled virtual object is in the camouflaged state.

In some examples according to the present disclosure, the first controlled virtual object is controlled to enter an initial state from a camouflaged state by: receiving a control instruction of the first user for a fourth virtual skill of the first controlled virtual object, and determining whether the first controlled virtual object is in the camouflaged state; and controlling the first controlled virtual object to enter the initial state from the camouflaged state, if the first controlled virtual object is in the camouflaged state.

Here, the fourth virtual skill may refer to the normal attack skill of the first controlled virtual object, and the fourth virtual skill is configured for causing harm to the second controlled virtual object.

In the embodiments of the present disclosure, if the first controlled virtual object is in the camouflaged state, when the first user controls the first controlled virtual object to release the normal attack, the first controlled virtual object may exit the camouflaged state and enter the initial state from the camouflaged state.

In step S104, the prompt information may refer to information displayed in the graphical user interface, and the prompt information is configured for prompting whether there is a camouflaged second controlled virtual object around the first controlled virtual object.

The prompt information includes the first prompt information and the second prompt information.

The first prompt information is configured for prompting that the second controlled virtual object with the same camouflage exists around the first controlled virtual object. As an example, the first prompt information may be a special mark, for example, the second controlled virtual object with the same camouflage is marked with red.

The second prompt information includes the first prompt sub-information and the second prompt sub-information. The first prompt sub-information is configured for prompting that there is a camouflaged second controlled virtual object around the first controlled virtual object. The second prompt sub-information is configured for prompting the appearance information of the camouflaged second controlled virtual object.

As an example, the first prompt sub-information may be text prompt information, for example, “Perception of a nearby sneaking party” is displayed by text in the graphical user interface.

The second prompt sub-information may be icon prompt information. For example, an icon corresponding to the appearance information of the camouflaged second controlled virtual object is displayed in the graphical user interface.

In some examples according to the present disclosure, the displaying prompt information that the second controlled virtual object is a camouflaged object in a graphical user interface of the first user includes: displaying the first prompt sub-information in the graphical user interface of the first user; and/or displaying the second prompt sub-information in the graphical user interface of the first user.

In the embodiments of the present disclosure, the existence of the second controlled virtual object around the first user may be prompted in two ways, one way is to prompt by text, and the other way is to prompt by an icon. In the above, the prompt by text is to inform the first user of the existence of the camouflaged second controlled virtual object of the hostile camp around the first controlled virtual object controlled thereby, and the prompt by an icon is to inform the first user of what appearance the camouflaged second controlled virtual object closest to the first controlled virtual object controlled thereby is.

In some examples according to the present disclosure, the method further includes: receiving a control instruction of the first user for a fourth virtual skill of the first controlled virtual object, and determining whether the second controlled virtual object in the camouflaged state is hit by the fourth virtual skill; if the second controlled virtual object in the camouflaged state is hit, obtaining current appearance information of the hit second controlled virtual object in the camouflaged state; and displaying in real time the second prompt sub-information corresponding to the hit second controlled virtual object in the camouflaged state, in the graphical user interface of the first user.

In the embodiments of the present disclosure, if the second controlled virtual object in the camouflaged state is hit by the fourth virtual skill released by the first controlled virtual object controlled by the first user, that is, hit by the normal attack skill, it indicates that the first user discovers the camouflaged second controlled virtual object around the first controlled virtual object controlled thereby. Because the single normal attack skill released by the first controlled virtual object may not be able to defeat the second controlled virtual object, the second prompt sub-information may be displayed in the graphical user interface of the first user, to prompt the first user to control the first controlled virtual object to pursue and attack the discovered camouflaged second controlled virtual object continuously.

In some examples according to the present disclosure, the second prompt sub-information of the hit second controlled virtual object in the camouflaged state displayed in real time is updated by: obtaining the current appearance information of the second controlled virtual object in the camouflaged state hit by the fourth virtual skill at the current moment; and updating the second prompt sub-information displayed in the graphical user interface of the first user, by using the second prompt sub-information corresponding to the current appearance information of the second controlled virtual object in the camouflaged state at the current moment.

Here, when the first user controls the first controlled virtual object to release the fourth virtual skill and hit a new second controlled virtual object in the camouflaged state, the latest second prompt sub-information is generated according to the current appearance information of the newly hit second controlled virtual object in the camouflaged state, and the second prompt sub-information displayed in the graphical user interface of the first user is replaced by the newly generated second prompt sub-information.

In some examples according to the present disclosure, after determining that the initial appearance information is inconsistent with the current appearance information, the method further includes: obtaining the current appearance information of the first controlled virtual object; determining whether the current appearance information of the first controlled virtual object is consistent with the current appearance information of the second controlled virtual object; and displaying the first prompt information for the second controlled virtual object, in the graphical user interface of the first user, if it is determined that the current appearance information of the first controlled virtual object is consistent with the current appearance information of the second controlled virtual object.

Here, the first prompt information may refer to a mark for distinguishing the second controlled virtual object with the same camouflage appearance as the first controlled virtual object in the camouflaged state.

As an example, the first prompt information may be a special effect of a special color added around the model of the controlled virtual object, or a special icon added around the model of the controlled virtual object.

In the embodiments of the present disclosure, the initial appearance information of the first controlled virtual object is inconsistent with the initial appearance information of the second controlled virtual object. Therefore, if the current appearance information of the first controlled virtual object is found to be consistent with the current appearance information of the second controlled virtual object, it indicates that the NPC that the first controlled virtual object camouflaged as and the NPC that the second controlled virtual object camouflaged as have the same appearance, then in order to help the first user distinguish the camouflaged second controlled virtual object, the first prompt information of the second controlled virtual object with the same camouflage appearance as the first controlled virtual object is directly displayed.

In some examples according to the present disclosure, the prompt information includes the second prompt information, and after the determining whether the current appearance information of the first controlled virtual object is consistent with the current appearance information of the second controlled virtual object, the method further includes: displaying the second prompt information that the second controlled virtual object is a camouflaged object, in the graphical user interface of the first user, if it is determined that the current appearance information of the first controlled virtual object is inconsistent with the current appearance information of the second controlled virtual object.

Here, when the first controlled virtual object is in the camouflaged state, if it is determined that the first controlled virtual object and the second controlled virtual object, both of which are in the camouflaged state, have the same appearance information, a second prompt information that the second controlled virtual object is a camouflaged object is displayed in the graphical user interface of the first user.

In some examples according to the present disclosure, the displaying the first prompt information for the second controlled virtual object in the graphical user interface of the first user if it is determined that the current appearance information of the first controlled virtual object is consistent with the current appearance information of the second controlled virtual object includes: determining the second controlled virtual object as a to-be-attacked controlled virtual object, if it is determined that the current appearance information of the first controlled virtual object is consistent with the current appearance information of the second controlled virtual object; and displaying the first prompt information for the to-be-attacked controlled virtual object, in the graphical user interface of the first user.

Here, if it is determined that the first controlled virtual object and the second controlled virtual object, both of which are in the camouflaged state, have the same appearance information, it indicates that the first controlled virtual object and the second controlled virtual object are camouflaged as NPCs of the same type of appearance. Therefore, after the first user controls the first controlled virtual object to release the first virtual skill, the second controlled virtual object with the same camouflage appearance as the first controlled virtual object in the camouflaged state may be marked to help the first user identify the second controlled virtual object in the camouflaged state.

In some examples according to the present disclosure, the method further include: selecting a target uncontrolled virtual object; and obtaining appearance information of the target uncontrolled virtual object, in response to a first control instruction of the first user for a second virtual skill of the first controlled virtual object, so that the first controlled virtual object enters the camouflaged state from the initial state.

Here, the uncontrolled virtual object may refer to a virtual object other than the controlled virtual object, and is used as a camouflaged object of the controlled virtual object.

As an example, the uncontrolled virtual object may be an NPC.

Exemplarily, the first control instruction may be a long-press operation for the second virtual skill.

In the embodiments of the present disclosure, the first user may control the first controlled virtual object to select an NPC to be camouflaged as, and simultaneously control the first controlled virtual object to release the second virtual skill, and control the first controlled virtual object to enter the camouflaged state from the initial state to have the appearance of the selected NPC.

In some examples according to the present disclosure, the selecting a target uncontrolled virtual object includes: displaying a plurality of uncontrolled virtual objects under a current perspective, in response to an adjustment instruction of the first user for the current perspective of the first controlled virtual object; and selecting the target uncontrolled virtual object from the plurality of uncontrolled virtual objects, in response to the second control instruction of the first user for the second virtual skill of the first controlled virtual object.

Here, when the first user controls the first controlled virtual object to select an NPC to be camouflaged as, the current perspective of the first controlled virtual object may be adjusted first. For example, the current perspective of the first controlled virtual object may be adjusted by sliding the screen to determine a plurality of NPCs under the current perspective, and one target is selected from the plurality of NPCs under the current perspective, where the appearance of the selected NPC is taken as the appearance to be camouflaged as.

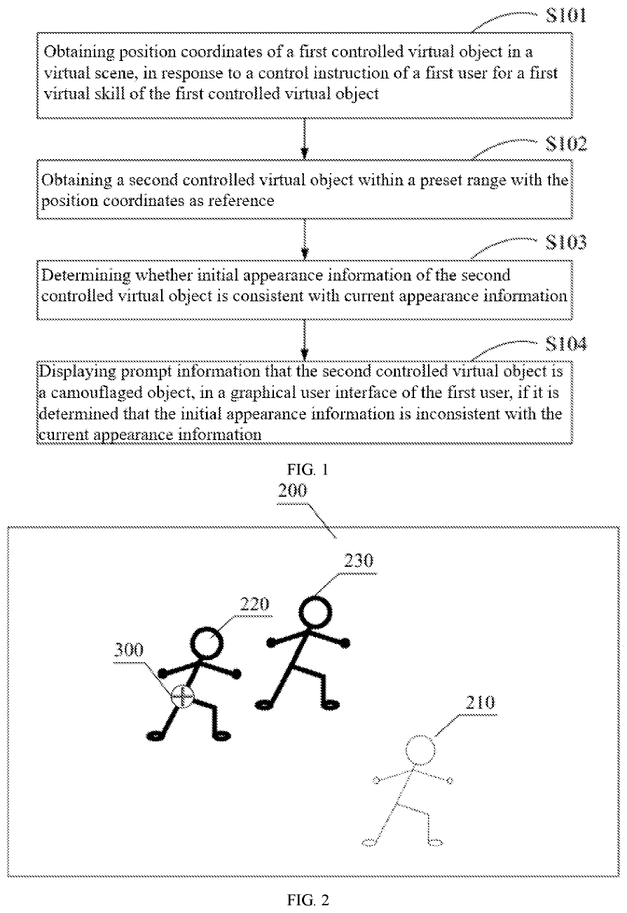

Next, with reference to FIG. 2, the selection process of the target uncontrolled virtual object is introduced.

FIG. 2 shows a schematic view of an interface for selecting a target uncontrolled virtual object provided by embodiments of the present disclosure.

As shown in FIG. 2, when the first user controls the first controlled virtual object to select a target uncontrolled virtual object, the current perspective of the first controlled virtual object is adjusted to the position shown in the graphical user interface 200, where in the graphical user interface 200, the first controlled virtual object 210, the uncontrolled virtual object 220 and the uncontrolled virtual object 230 are displayed. The uncontrolled virtual object 220 and the uncontrolled virtual object 230 are candidate uncontrolled virtual objects to be selected. When the first user inputs a second control instruction to control the first controlled virtual object to release the second virtual skill, for example, when the skill control corresponding to the second virtual skill is pressed for a long time, a selection sight 300 is displayed in the graphical user interface 200, and the first user may adjust the position of the selection sight 300. If the first user releases the long-press operation for the second virtual skill when the selection sight 300 aims at the uncontrolled virtual object 220, the uncontrolled virtual object 220 is determined as the target uncontrolled virtual object.

In some examples according to the present disclosure, after the obtaining appearance information of the target uncontrolled virtual object in response to a first control instruction of the first user for a second virtual skill of the first controlled virtual object, the method further includes: obtaining a target logic of the target uncontrolled virtual object; adding the obtained target logic to the first controlled virtual object, so that the first controlled virtual object has an interaction behavior corresponding to the target logic; and implementing a logical camouflage of the first controlled virtual object by using the target logic.

Here, the target logic may refer to the logical information corresponding to the target uncontrolled virtual object, and the target logic is configured for determining the behavior logic of the first controlled virtual object in the camouflaged state.

The target logic includes a hiding logic, a confrontation logic, and an imitation logic.

The hiding logic may refer to the display logic that prevents the second user from controlling the second controlled virtual object to detect the first controlled virtual object in a camouflaged state through various detection methods.

As an example, the hiding logic includes an identifier information hiding logic for the uncontrolled virtual object identifier, a map information hiding logic for a detection skill, and a model mark hiding logic for a detection prop.

The confrontation logic may refer to the behavioral logic when the second user controls the second controlled virtual object to attack the first controlled virtual object in the camouflaged state through various attack means.

As an example, the confrontation logic includes: a first confrontation logic for the second user to control the second controlled virtual object to launch a normal attack on the first controlled virtual object in the camouflaged state, and a second confrontation logic for the second user to control the second controlled virtual object to launch a special skill attack on the first controlled virtual object in the camouflaged state.

The imitation logic may refer to the behavioral logic when the second user controls the second controlled virtual object to interact with the first controlled virtual object in the camouflaged state through a non-confrontational prop or a non-confrontational virtual skill.

As an example, the imitation logic includes: a first imitation logic for the second user to control the second controlled virtual object to use the non-confrontational virtual prop on the first controlled virtual object in the camouflaged state, and a second imitation logic for the second user to control the second controlled virtual object to use the non-confrontational virtual skill on the first controlled virtual object in the camouflaged state.

In some examples according to the present disclosure, the implementing a logical camouflage of the first controlled virtual object by using the target logic includes: when the second controlled virtual object uses a detection method to detect the first controlled virtual object in the camouflaged state, using the hiding logic to make the second controlled virtual object unable to detect the first controlled virtual object, so as to hide the first controlled virtual object in the camouflaged state; when the second controlled virtual object attacks the first controlled virtual object in the camouflaged state, controlling the first controlled virtual object by using the confrontation logic, to release a third virtual skill to counterattack the second controlled virtual object; and when the second controlled virtual object performs non-confrontational interaction with the first controlled virtual object in the camouflaged state, controlling the first controlled virtual object by using the imitation logic to imitate behavior performance of the target uncontrolled virtual object against the non-confrontational interaction, so as to implement the logical camouflage in the camouflaged state.

Here, the detection method may refer to the detection method of performing detection through a detection skill or a detection prop.

The counterattack may refer to a behavior of counterattack that can cause harm to the attacker.

The behavior performance may refer to a non-confrontational interaction behavior, such as turning around, walking around, picking up items and checking the situation.

The third virtual skill may refer to the virtual skill of the first controlled virtual object. When the second controlled virtual object attacks the first controlled virtual object in the camouflaged state by using the target virtual skill, the first controlled virtual object uses the third virtual skill to counterattack.

In the embodiments of the present disclosure, when the second user controls the second controlled virtual object to approach the uncontrolled virtual object, the NPC identifier of the uncontrolled virtual object is displayed in the graphical user interface of the second user. Therefore, in order to achieve the camouflage effect, when the second user controls the second controlled virtual object to approach the first controlled virtual object in the camouflaged state, the NPC identifier of the target uncontrolled virtual object may also be displayed around the first controlled virtual object in the camouflaged state in the graphical user interface of the second user, through the identifier information hiding logic. In the above, the target uncontrolled virtual object is a camouflaged object of the first controlled virtual object in the camouflaged state.

When the second user controls the second controlled virtual object to use the detection skill, the uncontrolled virtual object may not be marked in the mini-map in the graphical user interface of the second user, but only the chasing party may be marked in the mini-map. Therefore, in order to achieve the camouflage effect, when the second user controls the second controlled virtual object to use the detection skill, the first controlled virtual object in the camouflaged state may not be marked in the mini-map in the graphical user interface of the second user, to achieve the camouflage purpose.

When the second user controls the second controlled virtual object to use the detection prop, the second controlled virtual object that is not in the camouflaged state may be marked in the virtual scene. Therefore, in order to achieve the camouflage effect, when the second user controls the second controlled virtual object to use the detection prop, the first controlled virtual object in the camouflaged state may not be marked in the virtual scene, to achieve the camouflage purpose.

When the second user controls the second controlled virtual object to release the normal attack skill to attack the first controlled virtual object in the camouflaged state, the first controlled virtual object is controlled by using the first confrontation logic to release the third virtual skill to counterattack against the normal attack skill released by the second controlled virtual object. Once the first controlled virtual object launches the counterattack, the first controlled virtual object may exit the camouflaged state and return to the initial state from the camouflaged state.

When the second user controls the second controlled virtual object to release the special skill to attack the first controlled virtual object in the camouflaged state, for example, release a stealing skill, and use the second confrontation logic to control the first controlled virtual object to release a third virtual skill to counterattack against the special skill released by the second controlled virtual object. Similarly, once the first controlled virtual object launches a counterattack, the first controlled virtual object may exit the camouflaged state and return to the initial state from the camouflaged state.

When the second user controls the second controlled virtual object to release the non-confrontational virtual prop to the uncontrolled virtual object, the uncontrolled virtual object may perform a non-confrontational behavior. In order to achieve the camouflage effect, when the second user controls the second controlled virtual object to release the non-confrontational virtual prop to the controlled virtual object in the camouflaged state, the first controlled virtual object in the camouflaged state is controlled by using the first imitation logic to perform the same non-confrontational behavior as the uncontrolled virtual object.

When the second user controls the second controlled virtual object to release the non-confrontational virtual skill to the uncontrolled virtual object, the uncontrolled virtual object may perform the corresponding non-confrontational behavior. In order to achieve the camouflage effect, when the second user controls the second controlled virtual object to release the non-confrontational virtual skill to the controlled virtual object in the camouflaged state, the first controlled virtual object in the camouflaged state is controlled by using the second imitation logic to perform the same non-confrontational behavior as the uncontrolled virtual object.

In the embodiments of the present disclosure, the logical camouflage is implemented by the following steps: determining whether the first controlled virtual object is attacked by the second controlled virtual object; determining whether the first controlled virtual object is in the camouflaged state, if the first controlled virtual object is attacked; and if the first controlled virtual object is in the camouflaged state, controlling the first controlled virtual object by using the confrontation logic, to release the third virtual skill to counterattack, and at the same time, enter the initial state from the camouflaged state; and

determining whether the second controlled virtual object initiates a non-confrontational interaction behavior against the first controlled virtual object; if the second controlled virtual object initiates the non-confrontational interaction behavior against the first controlled virtual object, determining whether the first controlled virtual object is in the camouflaged state; and if the first controlled virtual object is in the camouflaged state, controlling the first controlled virtual object by using the imitation logic, to imitate the behavior performance of the target uncontrolled virtual object against non-confrontational interaction.

In some examples according to the present disclosure, after receiving the second control instruction of the first user for the second virtual skill of the first controlled virtual object, the method further includes: determining whether the first controlled virtual object is in the camouflaged state; and controlling the first controlled virtual object to enter the initial state from the camouflaged state, if the first controlled virtual object is in the camouflaged state.

Here, if the first controlled virtual object is already in the camouflaged state, when controlling the first controlled virtual object to select a new camouflage target, the first user may disengage the camouflaged state of the first controlled virtual object, so that the first controlled virtual object returns to the initial state from the camouflaged state.

Compared with the in-game interaction method in the prior art, the present disclosure may determine the camouflaged second controlled virtual object within the preset range of the first controlled virtual object, and give a corresponding prompt in the graphical user interface of the first user. Compared with the in-game interaction method in the prior art, the problems of long match time and low interaction efficiency between users are solved.

Based on the same inventive concept, embodiments of the present disclosure further provide an in-game interaction apparatus corresponding to the in-game interaction method. The problem-solving principle of the apparatus in the embodiments of the present disclosure is similar to that of the above in-game interaction method in the embodiments of the present disclosure, thus the apparatus may be implemented by reference to the implementation of the method, which will not be repeated here.

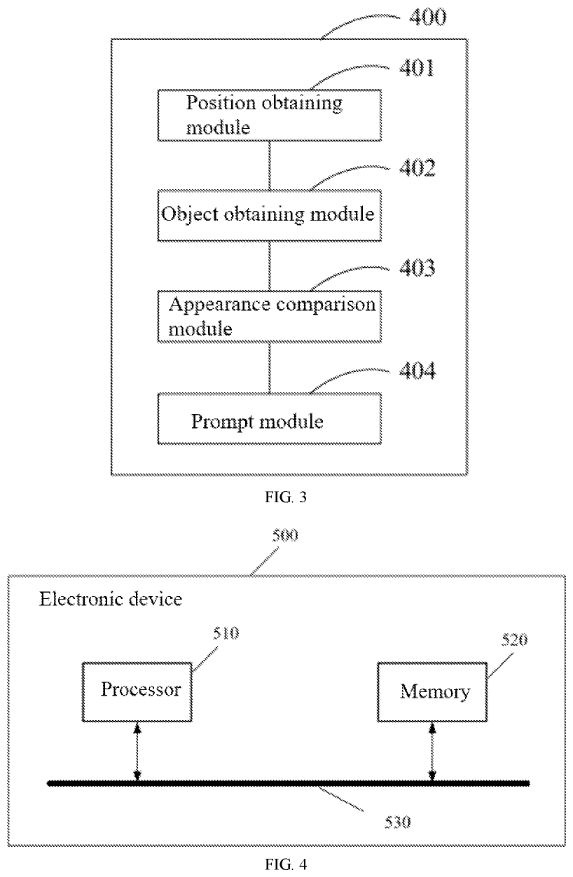

Referring to FIG. 3, FIG. 3 is a structural schematic view of an in-game interaction apparatus provided by embodiments of the present disclosure. As shown in FIG. 3, the in-game interaction apparatus 400 includes:

a position obtaining module 401, configured for obtaining position coordinates of a first controlled virtual object in a virtual scene, in response to a control instruction of a first user for a first virtual skill of the first controlled virtual object;

an object obtaining module 402, configured for obtaining a second controlled virtual object within a preset range with the position coordinates as reference, where the second controlled virtual object is controlled by a second user;

an appearance comparison module 403, configured for determining whether initial appearance information of the second controlled virtual object is consistent with current appearance information; and

a prompt module 404, configured for displaying prompt information that the second controlled virtual object is a camouflaged object, in a graphical user interface of the first user, if it is determined that the initial appearance information is inconsistent with the current appearance information.

In some examples, the prompt information includes the first prompt information, and the prompt module 404 is further configured for: obtaining the current appearance information of the first controlled virtual object; determining whether the current appearance information of the first controlled virtual object is consistent with the current appearance information of the second controlled virtual object; and displaying the first prompt information for the second controlled virtual object, in the graphical user interface of the first user, if it is determined that the current appearance information of the first controlled virtual object is consistent with the current appearance information of the second controlled virtual object.

In some examples, the prompt information includes second prompt information, and the appearance comparison module 403 is further configured for: displaying the second prompt information that the second controlled virtual object is a camouflaged object in the graphical user interface of the first user, if it is determined that the current appearance information of the first controlled virtual object is inconsistent with the current appearance information of the second controlled virtual object.

In some examples, the prompt module 404 is further configured for: determining the second controlled virtual object as a to-be-attacked controlled virtual object, if it is determined that the current appearance information of the first controlled virtual object is consistent with the current appearance information of the second controlled virtual object; and displaying the first prompt information for the to-be-attacked controlled virtual object, in the graphical user interface of the first user.

In some examples, the prompt information includes first prompt sub-information and second prompt sub-information, and the prompt module 404 is further configured for: displaying the first prompt sub-information in the graphical user interface of the first user, where the first prompt sub-information is configured for prompting existence of a camouflaged second controlled virtual object around the first controlled virtual object; and/or displaying the second prompt sub-information in the graphical user interface of the first user, where the second prompt sub-information is configured for prompting current appearance information of the camouflaged second controlled virtual object.

In some examples, the in-game interaction apparatus 400 further includes a camouflage module (not shown in the drawings), and the camouflage module is further configured for: selecting a target uncontrolled virtual object; and obtaining appearance information of the target uncontrolled virtual object, in response to a first control instruction of the first user for a second virtual skill of the first controlled virtual object, so that the first controlled virtual object enters a camouflaged state from an initial state by using the obtained appearance information, where the initial state is configured for representing a state of the first controlled virtual object using the initial appearance information, and the camouflaged state is configured for representing a state of the first controlled virtual object using the appearance information of the target uncontrolled virtual object.

In some examples, after the obtaining appearance information of the target uncontrolled virtual object in response to a first control instruction of the first user for a second virtual skill of the first controlled virtual object, the camouflage module is further configured for: obtaining a target logic of the target uncontrolled virtual object; adding the obtained target logic to the first controlled virtual object, so that the first controlled virtual object has an interaction behavior corresponding to the target logic; and implementing a logical camouflage of the first controlled virtual object by using the target logic.

In some examples, the camouflage module is further configured for: displaying a plurality of uncontrolled virtual objects under a current perspective, in response to an adjustment instruction of the first user for the current perspective of the first controlled virtual object; and selecting the target uncontrolled virtual object from the plurality of uncontrolled virtual objects, in response to the second control instruction of the first user for the second virtual skill of the first controlled virtual object.

In some examples, the camouflage module is further configured for: determining whether the first controlled virtual object is in the camouflaged state; and controlling the first controlled virtual object to enter the initial state from the camouflaged state, if the first controlled virtual object is in the camouflaged state.

In some examples, the target logic includes a hiding logic, a confrontation logic and an imitation logic, and the camouflage module is further configured for: when the second controlled virtual object uses a detection method to detect the first controlled virtual object in the camouflaged state, using the hiding logic to make the second controlled virtual object unable to detect the first controlled virtual object, so as to hide the first controlled virtual object in the camouflaged state; when the second controlled virtual object attacks the first controlled virtual object in the camouflaged state, controlling the first controlled virtual object by using the confrontation logic, to release a third virtual skill to counterattack the second controlled virtual object; and when the second controlled virtual object performs non-confrontational interaction on the first controlled virtual object in the camouflaged state, controlling the first controlled virtual object by using the imitation logic, to imitate behavior performance of the target uncontrolled virtual object against the non-confrontational interaction, so as to implement the logical camouflage in the camouflaged state.

In some examples, the camouflage module is further configured for: receiving a control instruction of the first user for a fourth virtual skill of the first controlled virtual object, and determining whether the first controlled virtual object is in the camouflaged state; and controlling the first controlled virtual object to enter the initial state from the camouflaged state, if the first controlled virtual object is in the camouflaged state.

In some examples, the prompt module 404 is further configured for: receiving a control instruction of the first user for a fourth virtual skill of the first controlled virtual object, and determining whether the second controlled virtual object in the camouflaged state is hit by the fourth virtual skill; if the second controlled virtual object in the camouflaged state is hit, obtaining current appearance information of the hit second controlled virtual object in the camouflaged state; and displaying in real time the second prompt sub-information corresponding to the hit second controlled virtual object in the camouflaged state, in the graphical user interface of the first user.

Referring to FIG. 4, FIG. 4 is a structural schematic view of an electronic device provided by embodiments of the present disclosure. As shown in FIG. 4, the electronic device 500 includes a processor 510, a memory 520 and a bus 530.

The memory 520 stores machine-readable instructions executable by the processor 510. When the electronic device 500 runs, the processor 510 communicates with the memory 520 through the bus 530. When the machine-readable instructions are executed by the processor 510, a method including the following steps may be performed:
obtaining position coordinates of a first controlled virtual object in a virtual scene, in response to a control instruction of a first user for a first virtual skill of the first controlled virtual object;
obtaining a second controlled virtual object within a preset range with the position coordinates as reference, where the second controlled virtual object is controlled by a second user;
determining whether initial appearance information of the second controlled virtual object is consistent with current appearance information; and
displaying prompt information that the second controlled virtual object is a camouflaged object, in a graphical user interface of the first user, if it is determined that the initial appearance information is inconsistent with the current appearance information.

In some examples, the prompt information includes first prompt information, and after determining that the initial appearance information is inconsistent with the current appearance information, the method further includes: obtaining the current appearance information of the first controlled virtual object; determining whether the current appearance information of the first controlled virtual object is consistent with the current appearance information of the second controlled virtual object; and displaying the first prompt information for the second controlled virtual object, in the graphical user interface of the first user, if it is determined that the current appearance information of the first controlled virtual object is consistent with the current appearance information of the second controlled virtual object.

In some examples, the prompt information includes second prompt information; and after the determining whether the current appearance information of the first controlled virtual object is consistent with the current appearance information of the second controlled virtual object, the method further includes: displaying the second prompt information that the second controlled virtual object is a camouflaged object, in the graphical user interface of the first user, if it is determined that the current appearance information of the first controlled virtual object is inconsistent with the current appearance information of the second controlled virtual object.

In some examples, the displaying the first prompt information for the second controlled virtual object in the graphical user interface of the first user if it is determined that the current appearance information of the first controlled virtual object is consistent with the current appearance information of the second controlled virtual object includes: determining the second controlled virtual object as a to-be-attacked controlled virtual object, if it is determined that the current appearance information of the first controlled virtual object is consistent with the current appearance information of the second controlled virtual object; and displaying the first prompt information for the to-be-attacked controlled virtual object, in the graphical user interface of the first user.

In some examples, the second prompt information includes first prompt sub-information and second prompt sub-information, and the displaying the second prompt information that the second controlled virtual object is a camouflaged object in the graphical user interface of the first user includes: displaying the first prompt sub-information in the graphical user interface of the first user, where the first prompt sub-information is configured for prompting existence of a camouflaged second controlled virtual object around the first controlled virtual object; and/or displaying the second prompt sub-information in the graphical user interface of the first user, where the second prompt sub-information is configured for prompting current appearance information of the camouflaged second controlled virtual object.

In some examples, the method further include: selecting a target uncontrolled virtual object; and obtaining appearance information of the target uncontrolled virtual object, in response to a first control instruction of the first user for a second virtual skill of the first controlled virtual object, so that the first controlled virtual object enters a camouflaged state from an initial state by using the obtained appearance information, where the initial state is configured for representing a state of the first controlled virtual object using the initial appearance information, and the camouflaged state is configured for representing a state of the first controlled virtual object using the appearance information of the target uncontrolled virtual object.

In some examples, after the obtaining appearance information of the target uncontrolled virtual object in response to a first control instruction of the first user for a second virtual skill of the first controlled virtual object, the method further includes: obtaining a target logic of the target uncontrolled virtual object; adding the obtained target logic to the first controlled virtual object, so that the first controlled virtual object has an interaction behavior corresponding to the target logic; and implementing a logical camouflage of the first controlled virtual object by using the target logic.

In some examples, the selecting a target uncontrolled virtual object includes: displaying a plurality of uncontrolled virtual objects under a current perspective, in response to an adjustment instruction of the first user for the current perspective of the first controlled virtual object; and selecting the target uncontrolled virtual object from the plurality of uncontrolled virtual objects, in response to the second control instruction of the first user for the second virtual skill of the first controlled virtual object.

In some examples, after receiving the second control instruction of the first user for the second virtual skill of the first controlled virtual object, the method further includes: determining whether the first controlled virtual object is in the camouflaged state; and controlling the first controlled virtual object to enter the initial state from the camouflaged state, if the first controlled virtual object is in the camouflaged state.

In some examples, the target logic includes a hiding logic, a confrontation logic and an imitation logic; and the implementing a logical camouflage of the first controlled virtual object by using the target logic includes: when the second controlled virtual object uses a detection method to detect the first controlled virtual object in the camouflaged state, using the hiding logic to make the second controlled virtual object unable to detect the first controlled virtual object, so as to hide the first controlled virtual object in the camouflaged state; when the second controlled virtual object attacks the first controlled virtual object in the camouflaged state, controlling the first controlled virtual object by using the confrontation logic, to counterattack the second controlled virtual object; and when the second controlled virtual object performs non-confrontational interaction on the first controlled virtual object in the camouflaged state, controlling the first controlled virtual object by using the imitation logic, to imitate behavior performance of the target uncontrolled virtual object against the non-confrontational interaction, so as to implement the logical camouflage in the camouflaged state.

In some examples, the first controlled virtual object is controlled to enter an initial state from a camouflaged state by: receiving a control instruction of the first user for a fourth virtual skill of the first controlled virtual object, and determining whether the first controlled virtual object is in the camouflaged state; and controlling the first controlled virtual object to enter the initial state from the camouflaged state, if the first controlled virtual object is in the camouflaged state.

In some examples, the method further includes: receiving a control instruction of the first user for a fourth virtual skill of the first controlled virtual object, and determining whether the second controlled virtual object in the camouflaged state is hit by the fourth virtual skill; if the second controlled virtual object in the camouflaged state is hit, obtaining current appearance information of the hit second controlled virtual object in the camouflaged state; and displaying in real time the second prompt information corresponding to the hit second controlled virtual object in the camouflaged state, in the graphical user interface of the first user.

The contents of the afore-mentioned embodiments of the in-game interaction method are also applicable to specific embodiments of the in-game interaction method in a game performed here, and will not be repeated here.

The electronic device provided by the embodiments of the present disclosure may determine the camouflaged second controlled virtual object within the preset range of the first controlled virtual object, and give a corresponding prompt in the graphical user interface of the first user. Compared with the in-game interaction method in the prior art, the problems of long match time and low interaction efficiency between users are solved.

Embodiments of the present disclosure further provide a computer-readable storage medium, a computer program is stored on the computer-readable storage medium, and the computer program, when run by a processor, may perform a method including the following steps:
obtaining position coordinates of a first controlled virtual object in a virtual scene, in response to a control instruction of a first user for a first virtual skill of the first controlled virtual object;
obtaining a second controlled virtual object within a preset range with the position coordinates as reference, where the second controlled virtual object is controlled by a second user;
determining whether initial appearance information of the second controlled virtual object is consistent with current appearance information; and
displaying prompt information that the second controlled virtual object is a camouflaged object, in a graphical user interface of the first user, if it is determined that the initial appearance information is inconsistent with the current appearance information.

In some examples, the prompt information includes first prompt information, and after determining that the initial appearance information is inconsistent with the current appearance information, the method further includes: obtaining the current appearance information of the first controlled virtual object; determining whether the current appearance information of the first controlled virtual object is consistent with the current appearance information of the second controlled virtual object; and displaying the first prompt information for the second controlled virtual object, in the graphical user interface of the first user, if it is determined that the current appearance information of the first controlled virtual object is consistent with the current appearance information of the second controlled virtual object.

In some examples, the prompt information includes second prompt information; and after the determining whether the current appearance information of the first controlled virtual object is consistent with the current appearance information of the second controlled virtual object, the method further includes: displaying the second prompt information that the second controlled virtual object is a camouflaged object, in the graphical user interface of the first user, if it is determined that the current appearance information of the first controlled virtual object is inconsistent with the current appearance information of the second controlled virtual object.

In some examples, the displaying the first prompt information for the second controlled virtual object in the graphical user interface of the first user if it is determined that the current appearance information of the first controlled virtual object is consistent with the current appearance information of the second controlled virtual object includes: determining the second controlled virtual object as a to-be-attacked controlled virtual object, if it is determined that the current appearance information of the first controlled virtual object is consistent with the current appearance information of the second controlled virtual object; and displaying the first prompt information for the to-be-attacked controlled virtual object, in the graphical user interface of the first user.

In some examples, the second prompt information includes first prompt sub-information and second prompt sub-information, and the displaying the second prompt information that the second controlled virtual object is a camouflaged object in the graphical user interface of the first user includes: displaying the first prompt sub-information in the graphical user interface of the first user, where the first prompt sub-information is configured for prompting existence of a camouflaged second controlled virtual object around the first controlled virtual object; and/or displaying the second prompt sub-information in the graphical user interface of the first user, where the second prompt sub-information is configured for prompting current appearance information of the camouflaged second controlled virtual object.

In some examples, the method further include: selecting a target uncontrolled virtual object; and obtaining appearance information of the target uncontrolled virtual object, in response to a first control instruction of the first user for a second virtual skill of the first controlled virtual object, so that the first controlled virtual object enters a camouflaged state from an initial state by using the obtained appearance information, where the initial state is configured for representing a state of the first controlled virtual object using the initial appearance information, and the camouflaged state is configured for representing a state of the first controlled virtual object using the appearance information of the target uncontrolled virtual object.

In some examples, after the obtaining appearance information of the target uncontrolled virtual object in response to a first control instruction of the first user for a second virtual skill of the first controlled virtual object, the method further includes: obtaining a target logic of the target uncontrolled virtual object; adding the obtained target logic to the first controlled virtual object, so that the first controlled virtual object has an interaction behavior corresponding to the target logic; and implementing a logical camouflage of the first controlled virtual object by using the target logic.

In some examples, the selecting a target uncontrolled virtual object includes: displaying a plurality of uncontrolled virtual objects under a current perspective, in response to an adjustment instruction of the first user for the current perspective of the first controlled virtual object; and selecting the target uncontrolled virtual object from the plurality of uncontrolled virtual objects, in response to the second control instruction of the first user for the second virtual skill of the first controlled virtual object.

In some examples, after receiving the second control instruction of the first user for the second virtual skill of the first controlled virtual object, the method further includes: determining whether the first controlled virtual object is in the camouflaged state; and controlling the first controlled virtual object to enter the initial state from the camouflaged state, if the first controlled virtual object is in the camouflaged state.

In some examples, the target logic includes a hiding logic, a confrontation logic and an imitation logic; and the implementing a logical camouflage of the first controlled virtual object by using the target logic includes: when the second controlled virtual object uses a detection method to detect the first controlled virtual object in the camouflaged state, using the hiding logic to make the second controlled virtual object unable to detect the first controlled virtual object, so as to hide the first controlled virtual object in the camouflaged state; when the second controlled virtual object attacks the first controlled virtual object in the camouflaged state, controlling the first controlled virtual object by using the confrontation logic, to counterattack the second controlled virtual object; and when the second controlled virtual object performs non-confrontational interaction on the first controlled virtual object in the camouflaged state, controlling the first controlled virtual object by using the imitation logic, to imitate behavior performance of the target uncontrolled virtual object against the non-confrontational interaction, so as to implement the logical camouflage in the camouflaged state.

In some examples, the first controlled virtual object is controlled to enter an initial state from a camouflaged state by: receiving a control instruction of the first user for a fourth virtual skill of the first controlled virtual object, and determining whether the first controlled virtual object is in the camouflaged state; and controlling the first controlled virtual object to enter the initial state from the camouflaged state, if the first controlled virtual object is in the camouflaged state.

In some examples, the method further includes: receiving a control instruction of the first user for a fourth virtual skill of the first controlled virtual object, and determining whether the second controlled virtual object in the camouflaged state is hit by the fourth virtual skill; receiving a control instruction of the first user for a fourth virtual skill of the first controlled virtual object, and determining whether the second controlled virtual object in the camouflaged state is hit by the fourth virtual skill; if the second controlled virtual object in the camouflaged state is hit, obtaining current appearance information of the hit second controlled virtual object in the camouflaged state; and displaying in real time the second prompt information corresponding to the hit second controlled virtual object in the camouflaged state, in the graphical user interface of the first user.

The contents of the afore-mentioned embodiments of the in-game interaction method are also applicable to specific embodiments of the in-game interaction method performed here, and will not be repeated here.

The computer-readable storage medium provided by the embodiments of the present disclosure may determine the camouflaged second controlled virtual object within the preset range of the first controlled virtual object, and give a corresponding prompt in the graphical user interface of the first user. Compared with the in-game interaction method in the prior art, the problems of long match time and low interaction efficiency between users are solved.

It can be clearly understood by those skilled in the art that for the convenience and conciseness of the description, the specific working processes of the above-described systems, apparatuses and units may refer to the corresponding processes in the afore-mentioned method embodiments, which will not be repeated here.

From the embodiments provided by the present disclosure, it should be understood that the disclosed systems, apparatuses, and methods may be implemented in other ways. The above-described apparatus embodiments are only schematic. For example, the division of the units is only a logical function division, and there may be another division mode in actual implementation. For another example, a plurality of units or components may be combined or integrated into another system, or some features may be ignored or not performed. On the other hand, the shown or discussed mutual coupling or direct coupling or communication may be indirect coupling or communication through some communication interfaces, apparatuses, or units, which may be in electrical, mechanical or other forms.

The units described as separate parts may or may not be physically separated, and the parts displayed as units may or may not be physical units, that is, they may be located in one place or distributed over a plurality of network units. Some or all of the units may be selected according to the actual needs to achieve the objectives of the embodiments.

In addition, the individual functional units in embodiments of the present disclosure may be integrated in one processing unit, or each functional unit may physically exist separately, or two or more units may be integrated in one unit.

If the functions are implemented in the form of software functional units and sold or used as independent products, they may be stored in a nonvolatile computer-readable storage medium executable by a processor. Based on this understanding, the essential part or the part that contributes to the prior art of the technical solutions of the present disclosure or a part of the technical solution may be embodied in the form of a software product. The computer software product is stored in a storage medium and includes a number of instructions to enable a computer device (which may be a personal computer, a server, or a network device, etc.) to perform all or some of the steps of the methods described in various embodiments of the present disclosure. The afore-mentioned storage medium includes: U disk, mobile hard disk, Read-Only Memory (ROM), Random Access Memory (RAM), magnetic disk or optical disk or other media that can store program codes.

Finally, it should be noted that the above-mentioned embodiments are only specific implementations of the present disclosure, for illustrating the technical solutions of the present disclosure, rather than limiting it, and the scope of protection of the present disclosure is not limited thereto. Although the present disclosure has been illustrated in detail with reference to the afore-mentioned embodiments, those ordinarily skilled in the art should understand that any person ordinarily skilled in the art may still modify or easily think of changes to the technical solutions described in the afore-mentioned embodiments within the technical scope disclosed in the present disclosure, or make equivalent substitution of some of the technical features thereof. However, these modifications, changes or substitutions do not make the essence of the corresponding technical solutions deviate from the spirit and scope of the technical solutions of the embodiments of the present disclosure, and shall fall within the scope of protection of the present disclosure. Therefore, the scope of protection of the present disclosure shall be subject to the scope of protection of the claims.

1. An in-game interaction method, comprising:
obtaining, by a terminal, position coordinates of a first controlled virtual object in a virtual scene, in response to a control instruction of a first user for a first virtual skill of the first controlled virtual object;
obtaining, by the terminal, a second controlled virtual object within a preset range in accordance with the position coordinates as reference, wherein the second controlled virtual object is controlled by a second user;
determining, by the terminal, whether initial appearance information of the second controlled virtual object is consistent with current appearance information; and
displaying prompt information that the second controlled virtual object is a camouflaged object, in a graphical user interface of the first user, in response to determining that the initial appearance information is inconsistent with the current appearance information.

2. The method according to claim 1, wherein the prompt information comprises first prompt information, and
the method further comprises:
obtaining current appearance information of the first controlled virtual object;
determining whether the current appearance information of the first controlled virtual object is consistent with the current appearance information of the second controlled virtual object; and
displaying the first prompt information for the second controlled virtual object, in the graphical user interface of the first user, in response to determining that the current appearance information of the first controlled virtual object is consistent with the current appearance information of the second controlled virtual object.

3. The method according to claim 2, wherein the prompt information comprises second prompt information, and
the method further comprises:
displaying the second prompt information that the second controlled virtual object is a camouflaged object, in the graphical user interface of the first user, in response to determining that the current appearance information of the first controlled virtual object is inconsistent with the current appearance information of the second controlled virtual object.

4. The method according to claim 3, wherein displaying the first prompt information for the second controlled virtual object in the graphical user interface of the first user in response to determining that the current appearance information of the first controlled virtual object is consistent with the current appearance information of the second controlled virtual object comprises:
determining the second controlled virtual object as a to-be-attacked controlled virtual object, in response to determining that the current appearance information of the first controlled virtual object is consistent with the current appearance information of the second controlled virtual object; and
displaying the first prompt information for the to-be-attacked controlled virtual object, in the graphical user interface of the first user.

5. The method according to claim 3, wherein the second prompt information comprises first prompt sub-information and second prompt sub-information, and
wherein displaying the second prompt information that the second controlled virtual object is the camouflaged object in the graphical user interface of the first user comprises:
displaying the first prompt sub-information in the graphical user interface of the first user, wherein the first prompt sub-information is configured for prompting existence of the camouflaged second controlled virtual object around the first controlled virtual object; or
displaying the second prompt sub-information in the graphical user interface of the first user, wherein the second prompt sub-information is configured for prompting current appearance information of the camouflaged second controlled virtual object.

6. The method according to claim 1, further comprising:
selecting a target uncontrolled virtual object; and
obtaining appearance information of the target uncontrolled virtual object in response to a first control instruction of the first user for a second virtual skill of the first controlled virtual object, so that the first controlled virtual object enters a camouflaged state from an initial state by using the obtained appearance information, wherein the initial state is configured for representing a state of the first controlled virtual object using the initial appearance information, and the camouflaged state is configured for representing a state of the first controlled virtual object using the appearance information of the target uncontrolled virtual object.

7. The method according to claim 6, further comprising:
obtaining a target logic of the target uncontrolled virtual object;
adding the obtained target logic to the first controlled virtual object, so that the first controlled virtual object has an interaction behavior corresponding to the target logic; and
implementing a logical camouflage of the first controlled virtual object by using the target logic.

8. The method according to claim 6, wherein selecting the target uncontrolled virtual object comprises:
displaying a plurality of uncontrolled virtual objects under a current perspective, in response to an adjustment instruction of the first user for the current perspective of the first controlled virtual object; and
selecting the target uncontrolled virtual object from the plurality of uncontrolled virtual objects, in response to the second control instruction of the first user for the second virtual skill of the first controlled virtual object.

9. The method according to claim 8, comprising:
determining whether the first controlled virtual object is in the camouflaged state; and
controlling the first controlled virtual object to enter the initial state from the camouflaged state, in response to determining that the first controlled virtual object is in the camouflaged state.

10. The method according to claim 7, wherein the target logic comprises a hiding logic, a confrontation logic, and an imitation logic; and
wherein implementing the logical camouflage of the first controlled virtual object by using the target logic comprises:
in response to determining that the second controlled virtual object uses a detection method to detect the first controlled virtual object in the camouflaged state, using the hiding logic to make the second controlled virtual object unable to detect the first controlled virtual object, so as to hide the first controlled virtual object in the camouflaged state;
in response to determining that the second controlled virtual object attacks the first controlled virtual object in the camouflaged state, controlling the first controlled virtual object by using the confrontation logic, to counterattack the second controlled virtual object; and
in response to determining that the second controlled virtual object performs non-confrontational interaction on the first controlled virtual object in the camouflaged state, controlling the first controlled virtual object by using the imitation logic, to imitate behavior performance of the target uncontrolled virtual object against the non-confrontational interaction, so as to implement the logical camouflage in the camouflaged state.

11. The method according to claim 1, wherein the first controlled virtual object is controlled to enter an initial state from a camouflaged state by:
receiving a control instruction of the first user for a fourth virtual skill of the first controlled virtual object, and determining whether the first controlled virtual object is in the camouflaged state; and
controlling the first controlled virtual object to enter the initial state from the camouflaged state, in response to determining that the first controlled virtual object is in the camouflaged state.

12. The method according to claim 5, further comprising:
receiving a control instruction of the first user for a fourth virtual skill of the first controlled virtual object, and determining whether the second controlled virtual object in the camouflaged state is hit by the fourth virtual skill;
in response to that the second controlled virtual object in the camouflaged state is hit, obtaining current appearance information of the hit second controlled virtual object in the camouflaged state; and
displaying in real time the second prompt information corresponding to the hit second controlled virtual object in the camouflaged state, in the graphical user interface of the first user.

13. (canceled)

14. An electronic device, comprising a processor, a storage medium and a bus, wherein the storage medium stores machine-readable instructions executable by the processor, the processor communicates with the storage medium through the bus when the electronic device runs, and the processor is configured for executing the machine-readable instructions to perform steps of an in-game interaction method,
wherein the in-game interaction method comprises:
obtaining a second controlled virtual object within a preset range in accordance with the position coordinates as reference, wherein the second controlled virtual object is controlled by a second user;
determining whether initial appearance information of the second controlled virtual object is consistent with current appearance information; and
displaying prompt information that the second controlled virtual object is a camouflaged object, in a graphical user interface of the first user, in response to determining that the initial appearance information is inconsistent with the current appearance information.

15. A non-transitory computer-readable storage medium, wherein a computer program is stored on the computer-readable storage medium, and the computer program, when run by a processor, performs steps of an in-game interaction method,
wherein the in-game interaction method comprises:
obtaining position coordinates of a first controlled virtual object in a virtual scene, in response to a control instruction of a first user for a first virtual skill of the first controlled virtual object;
obtaining a second controlled virtual object within a preset range in accordance with the position coordinates as reference, wherein the second controlled virtual object is controlled by a second user;
determining whether initial appearance information of the second controlled virtual object is consistent with current appearance information; and
displaying prompt information that the second controlled virtual object is a camouflaged object, in a graphical user interface of the first user, in response to determining that the initial appearance information is inconsistent with the current appearance information.

16. The method according to claim 1, wherein the control instruction comprises at least one of a single-click operation instruction, a double-click operation instruction, a long-press operation instruction, or a voice instruction.

17. The method according to claim 1, wherein the appearance information comprises at least one of model information or action information, wherein the model information comprises skin information corresponding to a model and skeleton information of the model.

18. The method according to claim 5, wherein the first prompt sub-information comprises text prompt information, and the second prompt sub-information comprises icon prompt information.

19. The method according to claim 12, wherein the fourth virtual skill is a normal attack skill of the first controlled virtual object, and the fourth virtual skill is configured for causing harm to the second controlled virtual object.

20. The electronic device according to claim 14, wherein the prompt information comprises first prompt information, and
the in-game interaction method further comprises:
obtaining current appearance information of the first controlled virtual object;
determining whether the current appearance information of the first controlled virtual object is consistent with the current appearance information of the second controlled virtual object; and
displaying the first prompt information for the second controlled virtual object in the graphical user interface of the first user, in response to determining that the current appearance information of the first controlled virtual object is consistent with the current appearance information of the second controlled virtual object.

21. The electronic device according to claim 20, wherein the prompt information comprises second prompt information, and
the in-game interaction method further comprises:
displaying the second prompt information that the second controlled virtual object is a camouflaged object in the graphical user interface of the first user, in response to determining that the current appearance information of the first controlled virtual object is inconsistent with the current appearance information of the second controlled virtual object.
